(19) United States
(12) Patent Application Publication
(10) Pub. No.: US 2014/0314515 A1
(43) Pub. Date: Oct. 23, 2014

(54) Threaded Component Locking Mechanism

(71) Applicant: Park Hannifin Corporation, Cleveland, OH (US)

(72) Inventor: Westin S. Baker, Olmsted Township, OH (US)

(73) Assignee: PARKER HANNIFIN CORPORATION, Cleveland, OH (US)

(21) Appl. No.: 14/356,685

(22) PCT Filed: Nov. 8, 2012
(86) PCT No.: PCT/US2012/064136

§ 371 Date: May 7, 2014

Related U.S. Application Data
(60) Provisional application No. 61/556,996, filed on Nov. 8, 2011.

(51) Int. Cl. F16B 39/32

(52) U.S. Cl. CPC F16B 39/32
USPC 411/326

(57) ABSTRACT

A threaded fastening device is provided which utilizes a plurality of retractable pawls (46,38) positioned in a first register (22) surface of the fastening device. The pawls ratchet against a plurality of teeth (28) formed on a second register surface (32) when the first register surface is rotated in a tightening direction against the second register surface. The pawls are adapted to prevent disengagement from the plurality of teeth and thus prevent further rotation when the when the first register surface is rotated in a loosening direction against the second register surface.

### CROSS REFERENCE TO RELATED APPLICATIONS

The present application claims the benefit of the filing date of U.S. Provisional Patent Application Ser. No. 61556996, filed Nov. 8, 2011, the disclosure of which is incorporated herein by reference in its entirety.

### TECHNICAL HELD

The present invention relates to a ratchet lock interface for a threaded fastener application.

### BACKGROUND

Locking threaded fasteners and threaded connecting devices of a wide variety of types are available which reduce the tendency of male, generally cylindrical, threaded components from altering their position in relation to their corresponding female threaded component, thereby reducing the tendency of such threaded fasteners and threaded connecting devices to loosen and come apart in response to vibration, expansion, contraction and other movement. Many such fasteners function in this regard by increasing friction between the mated threads of the male and female components or between the fastener and the parts joined by the fastener. Examples include: lock washers, tooth washers, blind thread bores filled with resilient inserts, and screw thread profiles that jam or deform when tightened. Other such fasteners and connections function by increasing the friction between the engaging surfaces of the head of the male component and work piece, or between the female component and Work piece.

The increased friction of these fasteners makes rotation more difficult between the male and female components, thereby preventing inadvertent release or loosening of the male and female components. A drawback of all these approaches is that the male and female components can loosen at any axial pressure or tension less than that required to strip the male component out of the female component, since the threads in each case fall away in the direction of axial pressure or tension, a portion of such pressure or tension is translated into a rotational force tending to loosen the components. Also, fasteners using these approaches generally require high torque to install or require greater loads to be effective than is desirable to apply to some joints. Self-locking accessories such as cotter pins, lock wires, and nut assemblies comprising a first working nut and a second locking nut part have the drawback of requiring additional installation steps.

### SUMMARY

At least one embodiment of the invention provides a threaded fastening device comprising: a first fastening member having an internal thread and a first register surface; a second fastening member having an external thread on which the internal thread of the first fastening member is received; the second fastening member having a second register surface against which the first register surface of the first fastening member contacts when the first fastening member is rotated toward the second fastening member; a retractable pawl biased to extend from one of the first and second register surfaces; at least one recess formed in the other of the first and second register surfaces, the pawl biased to engage the at least one recess when aligned therewith, the pawl shaped to prevent disengagement of the projection from the at least one recess when rotated in a loosening direction and shaped to allow disengagement when rotated in a tightening direction.

At least one embodiment of the invention provides a fastening member comprising: a head having an externally threaded shaft extending therefrom; a register surface formed on a portion of the head generally perpendicular to a rotational axis of the threaded shaft; a plurality of cavities formed in the head and opening at the register surface; a pawl moveably positioned in each cavity; a spring biasing each pawl to extend outward from each cavity to extend beyond the register surface of the head; each pawl configured to engage a corresponding recess of another register surface against which the head is moved toward to prevent disengagement of the pawl from the recess when the head is rotated in a loosening direction and shaped to allow disengagement of the pawl with the recess when the head is rotated in a tightening direction.

At least one embodiment of the invention provides a fastening member comprising: an annular body having an internal thread; a register surface formed generally perpendicular to a rotational axis of the annular body; a plurality of cavities formed in the annular body and opening at the register surface; a pawl moveably positioned in each cavity; a spring biasing each pawl to extend outward from each cavity to extend beyond the register surface of the annular body; each pawl configured to engage a corresponding recess of another register surface against which the annular body is moved toward to prevent disengagement of the pawl from the recess when the annular body is rotated in a loosening direction and shaped to allow disengagement when the annular body is rotated in a tightening direction.

### BRIEF DESCRIPTION OF THE DRAWINGS

Embodiments of this invention will now be described in further detail with reference to the accompanying drawings, in which:

FIG. 1 is a perspective view of an internally threaded fastener having a stepped annular face;

FIG. 2 is a perspective view of an externally threaded fastener having a plurality of spring loaded pawls;

FIG. 3 is a perspective view of a pawl extending from a sleeve;

FIG. 4 is a cross-sectional view of the pawl mechanism; and

FIG. 5 is a cross-sectional view of an embodiment of the fastening system of the present invention.

### DETAILED DESCRIPTION OF THE DRAWING

Referring to FIG. 1, a female fastening member 20 is shown. The female fastening member 20 is formed as an annular body 26 having an internal thread 24 formed thereon. The annular body 26 includes a register surface 22 formed generally perpendicular to a central axis of the internal threads 24. The register surface 22 comprises a plurality of steps or teeth 28 radially formed on the register surface 22.

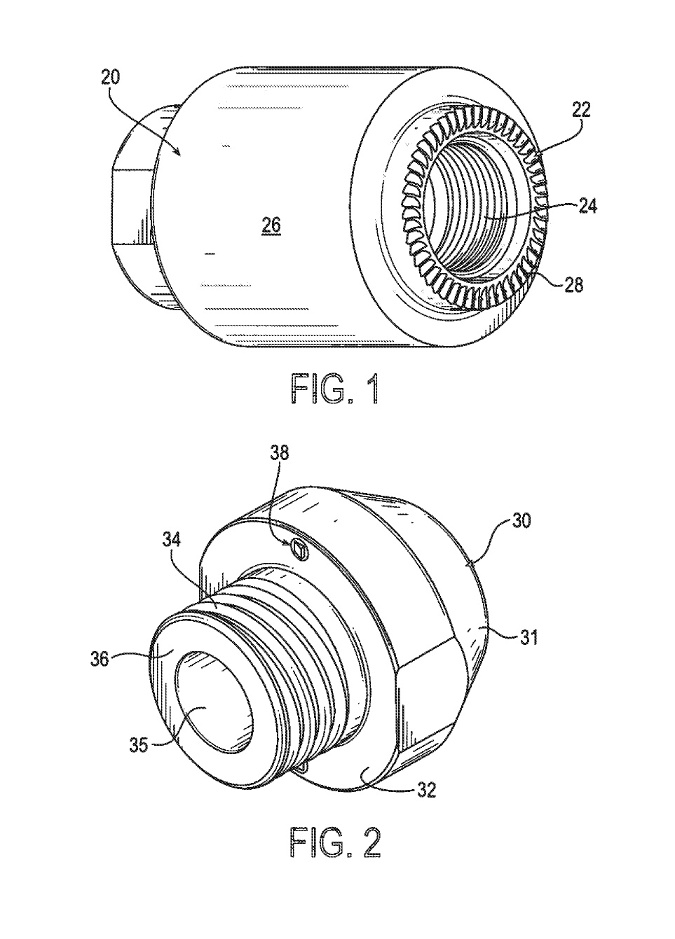

Referring to FIG. 2, a male fastening member 30 is shown comprising a head portion 31 having a shaft 36 extending from the head 31. The shaft 36 has external threads 34 formed thereon and the shaft 36 may be solid or may have an aperture 35 therethrough as shown. The head portion 31 includes a register surface 32 formed on a portion of the head generally perpendicular to a rotational axis of the threaded shaft 36. The head portion 31 includes a plurality of retractable pawl assemblies 38.

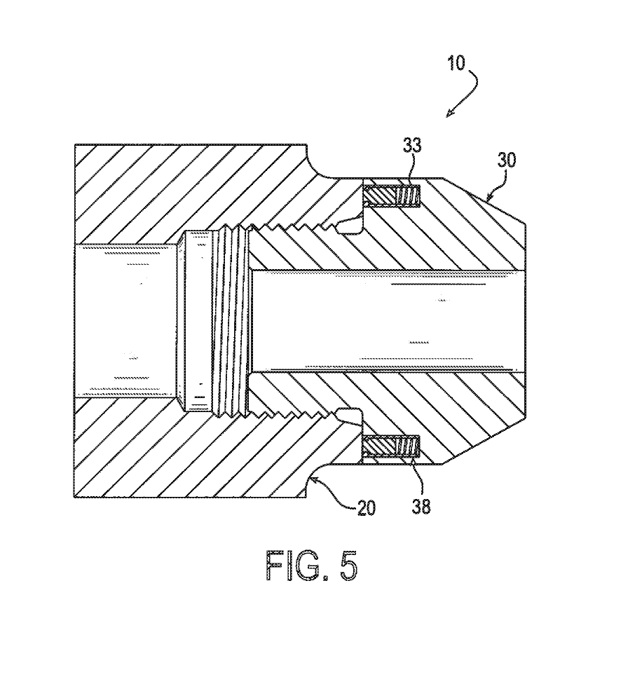

A plurality of cavities 33 are formed in the head portion 31, the cavities 33 opening at the register surface 32 as best shown in FIG. 5. A pawl 46 is moveably positioned in each cavity 33. A biasing member such as spring 44 is positioned at the bottom of each cavity 33 for biasing each pawl 46 to extend outwardly from each cavity 33 to extend beyond the register surface 32 of the head 31.

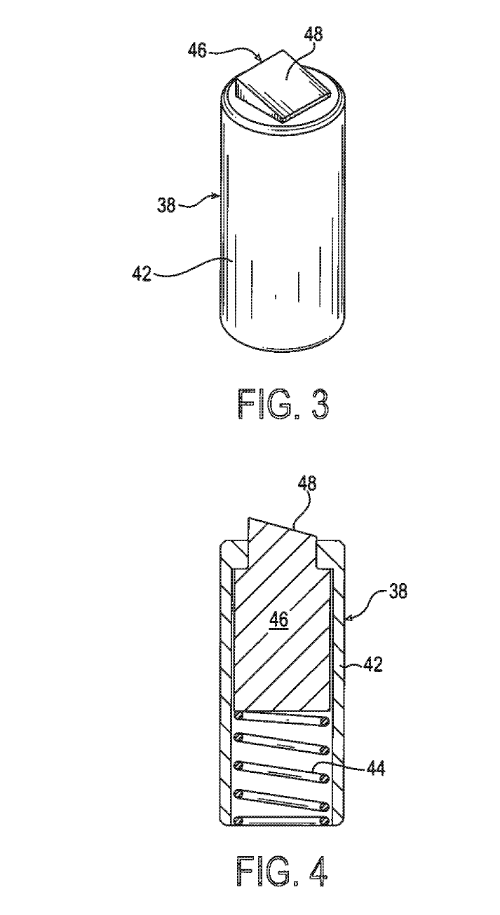

Referring to FIGS. 3 and 4, the pawl assemblies 38 may also include a sleeve 42 positioned in each cavity. The sleeve 42 is shaped to allow movement of the pawl 46 while retaining the pawl 46 at least partially within the cavity 33 as well as providing a housing for the biasing member 44. Each pawl 46 is configured as a step or angled tooth 48 to engage a corresponding recess (in the embodiment shown formed by the steps or teeth 28 on register surface 22) of another register surface against which the head 31 is moved toward to prevent disengagement of the pawl 46 from the recess when the head 31 is rotated in a loosening direction and shaped to allow disengagement when the head 31 is rotated in a tightening direction.

The fastener 10 is designed such that when the pawls 46 engage the teeth 28, the fastener can no longer be disengaged. In one embodiment, the pawls 46 are constructed such that the pawls 46 will fail at a predetermined force of disengagement, allowing the fastener 10 to disengage. This predetermined force of disengagement is at a level that only the pawl assemblies 38 would be damaged and not the remaining fastener 10. The pawl assemblies 38 could then be replaced and the fastener 10 reused.

While the fastener 10 has been shown in one configuration, other configurations are also contemplated. The pawl assemblies could be positioned on the register surface of the female fastening member while the ratchet teeth could be positioned on the register surface of a male fastening member or of an intermediate body being secured by the fastening members. The pawl could be oriented to engage teeth on a circumferential surface, either internal or externally positioned.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

1. A threaded fastening device comprising:
a first fastening member having an internal thread and a first register surface;
a second fastening r Member having an external thread on which the internal thread of the first fastening member is received;
the second fastening member having a second register surface against which the first register surface of the first fastening member contacts when the first fastening rr ember is rotated toward the second fastening member;
a retractable pawl biased to extend from one of the first and second register surfaces;
at least one recess formed in the other of the first and second register surfaces, the pawl biased to engage the at least one recess when aligned therewith, the pawl shaped to prevent disengagement of the projection from the at least one recess when rotated in a loosening direction and shaped to allow disengagement when rotated in a tightening direction.

2. The threaded fastening device of claim 1, wherein the at least one recess is a plurality of recesses.

3. The threaded fastening device of claim 1, wherein the at least one recess is a plurality of recesses formed as ratchet teeth.

4. The threaded fastening device of claim 1, wherein the retractable pawl is positioned in the first fastening member.

5. The threaded fastening device of claim 1, wherein the first register surface is formed on the second fastening member.

6. The threaded fastening device of claim 1, wherein the first register surface is formed on a body to be secured by the fastening device.

7. The threaded fastening device of claim 1, wherein the retractable pawl is a plurality of retractable pawls.

8. The threaded fastening device of claim 1, wherein the retractable pawl comprises a sleeve and a pawl member, the pawl member retractably biased to extend from an end of the sleeve.

9. The threaded fastening device of claim 1, wherein the pawl is biased into engagement by a spring.

10. The threaded fastening device of claim 8, wherein the pawl is retractably biased to extend from an end of the sleeve by a spring.

11. A fastening member comprising:
a head having an externally threaded shaft extending therefrom;
a register surface formed on a portion of the head generally perpendicular to a rotational axis of the threaded shaft;
a plurality of cavities formed in the head and opening at the register surface;
a pawl moveably positioned in each cavity;
a spring biasing each pawl to extend outward from each cavity to extend beyond the register surface of the head;
each pawl configured to engage a corresponding recess of another register surface against which the head is moved toward to prevent disengagement of the pawl from the recess when the head is rotated in a loosening direction and shaped to allow disengagement of the pawl with the recess when the head is rotated in a tightening direction.

12. The fastening member of claim 11 further comprising a sleeve positioned in each cavity, the sleeve shaped to allow movement of the pawl while retaining the pawl at least partially within the cavity.

13. A fastening member comprising:
an annular body having an internal thread;
a register surface formed generally perpendicular to a rotational axis of the annular body;
a plurality of cavities formed in the annular body and opening at the register surface;
a pawl moveably positioned in each cavity;
a spring biasing each pawl to extend outward from each cavity to extend beyond the register surface of the annular body;
each pawl configured to engage a corresponding recess of another register surface against which the annular body is moved toward to prevent disengagement of the pawl from the recess when the annular body is rotated in a loosening direction and shaped to allow disengagement when the annular body is rotated in a tightening direction.

14. The fastening member of claim 13 further comprising a sleeve positioned in each cavity, the sleeve shaped to allow movement of the pawl while retaining the pawl at least partially within the cavity.
